(19) United States
(12) Patent Application Publication
(10) Pub. No.: US 2007/0298292 A1
(43) Pub. Date: Dec. 27, 2007

(54) Regenerating an adsorption bed in a fuel cell-based system

(76) Inventors: Robert A. Sinuc, Glenmont, NY (US); Arne W. Ballantine, Menlo Park, CA (US)

Correspondence Address: TROP PRUNER & HU, PC, 1616 S. VOSS ROAD, SUITE 750, HOUSTON, TX, 77057-2631, US

(21) Appl. No.: 11/474,800

(22) Filed: Jun. 23, 2006

(51) Int. Cl. H01M 8/04; H01M 8/06

(52) U.S. Cl. 429/19; 429/34; 429/17

(57) ABSTRACT

A system includes a fuel generator, a thermal swing adsorber and a fuel cell-based power generator. The fuel generator provides fuel for the fuel cell-based power generator and has an exhaust flow. The thermal swing adsorber includes a bed to enrich a first oxidant flow with oxygen to produce a second oxidant flow. The fuel cell-based power generator produces electrical power in response to the second oxidant flow and the fuel. The system includes a subsystem to route the exhaust flow from the fuel generator to the thermal swing adsorber to regenerate the bed.

### BACKGROUND

The invention generally relates to regenerating an adsorption bed in a fuel cell-based system.

A fuel cell is an electrochemical device that converts chemical energy directly into electrical energy. There are many different types of fuel cells, such as solid oxide, molten carbonate, phosphoric acid, methanol and proton exchange member (PEM) fuel cells.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

### SUMMARY

In an embodiment of the invention, a system includes a fuel generator, a thermal swing adsorber and a fuel cell-based power generator. The fuel generator provides fuel for the fuel cell-based power generator and has an exhaust flow. The thermal swing adsorber includes a bed to enrich a first oxidant flow with oxygen to produce a second oxidant flow. The fuel cell-based power generator produces electrical power in response to the second oxidant flow and the fuel. The system includes a subsystem to route the exhaust flow from the fuel generator to the thermal swing adsorber to regenerate the bed.

In another embodiment of the invention, a system includes a pressure swing adsorber, a fuel generator and a fuel cell-based power generator. The pressure swing adsorber provides a fuel flow, and the fuel generator purifies the fuel flow to produce substantially purified fuel. The fuel cell-based power generator produces electrical power in response to an oxidant flow and the substantially purified fuel. The system includes a subsystem to route a flow that is associated with the fuel cell-based power generator to regenerate the bed of the pressure swing adsorber.

Advantages and other features of the invention will become apparent from the following drawing, description and claims.

### BRIEF DESCRIPTION OF THE DRAWING

FIG. 1 is a schematic diagram of a combined refueling and fuel cell-based power generation station according to an embodiment of the invention.

FIGS. 2, 3 and 4 are flow diagrams of techniques to use and regenerate a thermal swing adsorption bed of the station of FIG. 1 according to embodiments of the invention.

FIGS. 5, 6 and 7 are flow diagrams depicting techniques to use and regenerate a pressure swing adsorption bed of the station of FIG. 1 according to embodiments of the invention.

FIG. 8 is a schematic diagram of the fuel cell-based power generator of FIG. 1 according to an embodiment of the invention.

FIG. 9 is a schematic diagram of the fuel generator of FIG. 1 according to an embodiment of the invention.

### DETAILED DESCRIPTION

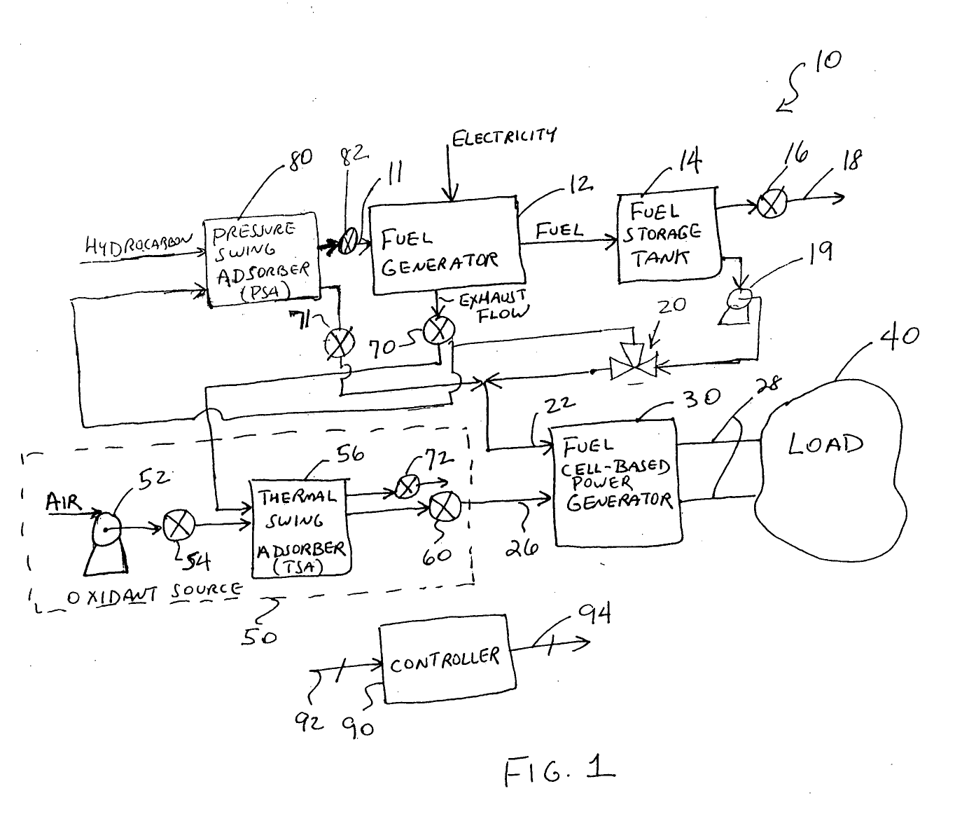

FIG. 1 depicts an exemplary combined refueling and power generation station 10, in accordance with embodiments of the invention. The station 10 is a multifunctional system, which includes a fuel generator 12 that produces fuel both for a fuel cell-based power generator 30 (of the station 10) and for fuel cell-based vehicles, which may be re-fueled at the station 10. More specifically, in accordance with some embodiments of the invention, the fuel generator 10, during off peak pricing hours, generates fuel (hydrogen, for example), which is stored in a fuel storage tank 14. A fuel cell-based vehicle may access the stored fuel via an outlet 18 (controlled by a valve 16) of the tank 14.

Besides producing and storing fuel, the station 10 also generates electricity for a load 40 (a residential load (i.e., the electrical loads of a house) or the load presented by a commercial re-fueling station, as examples). In this regard, during peak pricing times or times when grid electricity is not available, the fuel cell-based power generator 30 of the station 10 uses fuel from the fuel storage tank for purposes of generating electricity for the load 40.

For purposes of maximizing the overall efficiency of the station 10 and minimizing emissions (such as carbon dioxide emissions, for example), the efficiencies of the fuel generator 12 and the fuel cell-based power generator 30 are of paramount importance. Although many possibilities may exist to raise the efficiency of the fuel cell-based power generator 30, one technique to raise the efficiency of the generator 30 is to increase the partial pressure of the reactant oxygen that is supplied to the generator 30. In this regard, the fuel cell-based power generator 30 produces electricity in response to an incoming fuel flow (received at its anode inlet 22) and an incoming oxidant flow (received at its cathode inlet 26).

For purposes of providing the oxidant flow to the fuel cell-based power generator 30, the station 10 includes an oxidant source 50. As described further below, the oxidant source 50 includes a thermal swing adsorber (TSA) 56 that enriches the oxidant flow to the fuel cell-based power generator 30 with oxygen.

More specifically, the oxidant source 50 includes, in accordance with some embodiments of the invention, an air blower 52 (a positive displacement type or centrifugal type blower, as examples) that, during the operation of the fuel cell-based power generator 30, furnishes a flow of air to the TSA 56 which enriches the flow with oxygen. The flow exits the TSA 56 and is routed to the cathode inlet 26 of the fuel cell-based power generator 30.

It is noted that the oxygen partial pressure from the flow that exits the air blower 52 may be near an atmospheric ambient partial pressure. Therefore, the efficiency of the fuel cell-based power generator 30 is not significantly enhanced by use of the air blower 52 alone. Although the air blower 52 may be replaced with another air source, such as a compressed air source, in lieu of the TSA 56, the efficiency of the station may not be increased, due to the electrical power consumption by the compressor.

The TSA 56 contains at least one fixed bed that enriches the incoming air flow with oxygen to produce the outgoing enriched oxidant flow. In accordance with some embodiments of the invention, the bed of the TSA 56 enriches the oxidant flow by capturing nitrogen from the incoming air stream when the bed is cold. However, regularly, the bed must be regenerated to release the captured nitrogen. This involves cycling the thermal state of the TSA 56 and subjecting its bed to a purge flow. More specifically, in accordance with some embodiments of the invention, the bed of the TSA 56 may be expected to be regenerated every one quarter or half a twenty four hour period of a given day. For purposes of performing this regeneration, the station 10 routes an exhaust flow from the fuel generator 12 through the TSA 56, in accordance with some embodiments of the invention.

More particularly, in accordance with some embodiments of the invention, the fuel generator 12 and the fuel cell-based power generator 30 do not operate simultaneously. Rather, the fuel generator 12 and the fuel cell-based power generator 30 operate pursuant to mutually exclusive schedules so that the fuel generator 12 operates during off-peak pricing hours (for the incoming hydrocarbon flow and for grid electricity), while the fuel cell-based power generator 30 is shut down; and the fuel cell-based power generator 30 operates during peak pricing hours (from the fuel that is stored in the storage tank 14) while the fuel generator 12 is shut down.

Due to the above-described timing of the operating schedules of the fuel generator 12 and the fuel cell-based power generator 30, the station 10 uses the operation of the fuel generator 12 to regenerate the bed of the TSA 56 while the fuel cell-based power generator 30 is shut down and thus, not consuming oxygen. In this regard, during its operation, the fuel generator 12 produces a heated exhaust flow that is routed to the TSA 56 during the shut down state of the fuel cell-based power generator 30 for purposes of regenerating the bed of the TSA 56. During this regeneration, the flow from the TSA 56 is isolated from the fuel cell-based power generator 30. During the operation of the fuel cell-based power generator 30, the fuel generator 12 is shut down and isolated so that no exhaust flow flows to the TSA 56; and in the operational state of the fuel cell-based power generator 30, the cathode inlet 26 of the generator 30 receives the oxygen-enriched flow from the TSA 56.

The exhaust flow from the fuel generator 12 performs two functions with respect to regenerating the bed of the TSA 56: the flow transfers thermal energy to the bed of the TSA 56 for purposes of causing the bed to transition to a state in which the bed releases captured nitrogen; and the gas of the exhaust flow purges the released nitrogen from the bed.

The TSA's bed is not the only bed of the station 10 that may be regenerated in accordance with some embodiments of the invention. For example, in accordance with some embodiments of the invention, one or more fixed beds of a pressure swing adsorber (PSA) 80 of the station 10 may be regenerated in accordance with some embodiments of the invention. More specifically, the PSA 80 has at least one fixed bed that removes one or more components from the incoming hydrocarbon stream. For example, the PSA 80 may include one or more beds that remove water and carbon monoxide from the incoming hydrocarbon flow. The bed(s) of the PSA 80 need to be periodically regenerated to remove the trapped water and carbon monoxide; and, as further described below, in accordance with some embodiments of the invention, fuel that is stored in the fuel storage tank 14 is used to flow through the PSA 80 to regenerate the bed(s).

More specifically, for the case in which the fuel that is stored in the fuel storage tank 14 is purified and dry hydrogen; this hydrogen is routed to the PSA 80 to purge the bed(s) of the PSA 80. The regeneration occurs when the fuel generator 12 is shut down and the fuel cell-based power generator 30 is operational, in accordance with some embodiments of the invention. As further described below, the fuel flow that passes through the PSA 80 may be either an exhaust flow from the fuel cell-based power generator 30 or may be an incoming reactant flow to the fuel cell-based power generator 30, depending on the particular embodiment of the invention.

The station 10 includes various valves to control the above-described flows in connection with the fuel generation, power production and regeneration operations. For example, in accordance with some embodiments of the invention, a valve 60 is selectively opened and closed to regulate the flow from the TSA 56 to the cathode inlet 26 of the fuel cell-based power generator 30. Additionally, a valve 54 regulates the flow of air from the air blower 52 to the inlet of the TSA 56. Therefore, when the TSA 56 is being regenerated, the valves 54 and 60 may be closed for purposes of isolating the TSA 56 from the incoming air flow from the blower 52 and isolating the fuel cell-based power generator 30 from the purge flow.

For purposes of controlling the regenerating exhaust flow to the TSA 56, the station 10 includes a valve 70 that is located between an exhaust outlet of the fuel generator 12 and an inlet of the TSA 56. When the valve 70 is closed during the normal operation of the fuel cell-based power generator 30, the TSA 56 is isolated from the exhaust flow from the fuel generator 12. Similarly, a valve 72 that is connected to an outlet of the TSA 56 is closed. However, during the regeneration of the TSA 56, the valves 70 and 72 are open to route the exhaust flow through the TSA 56.

The station 10 also includes valves for purposes of controlling the regeneration of the PSA 80. More specifically, in accordance with some embodiments of the invention, a valve 82 is located between an outlet of the PSA 80 and an inlet 11 of the fuel generator 12. The valve 82 is open during the operation of the fuel generator 12 so that the fuel generator 12 receives the hydrocarbon flow from the PSA 80. However, during the regeneration of the PSA 80, the valve 82 is closed.

For embodiments of the invention in which fuel from the fuel storage tank 14 passes through the PSA 80 and then into the anode inlet 22 of the fuel cell-based power generator 30 during the regeneration of the bed(s) of the PSA 80, the station 10 includes a three-way valve 20 and a valve 71. The three-way valve 20 controls communication between an outlet of the fuel storage tank 14, an inlet of the PSA 80 and the anode inlet 22 of the fuel cell-based power generator 30. More specifically, during operation of the fuel cell-based power generator 30, the valve 20 is configured to establish communication between the outlet of the fuel storage tank 14 and the anode inlet 22 so that a blower 19 (connected to the outlet of the fuel storage tank 14) establishes a flow of fuel into the anode inlet 22. However, during the regeneration of the PSA 80, the valve 20 is configured to establish communication between the outlet of the fuel storage tank 14 and an inlet of the PSA 80. Thus, purified and dry hydrogen (for example) flows from the fuel storage 14 and through the PSA 80.

An open valve 71 (which is normally closed when the PSA 80 is not being regenerated) communicates the flow from the PSA 80 to the anode inlet 22. Thus, in this configuration, purified and dry hydrogen flows from the fuel storage tank 14 through the bed(s) of the PSA 80 and enters the fuel cell-based power generator 30. As noted above, the flow through the PSA 80 may also be directed to the cathode inlet 26 of the fuel cell-based power generator 30; and additionally, an exhaust flow of the fuel cell-based power generator 30 may be used to regenerate the bed(s) of the PSA 80 in accordance with other embodiments of the invention.

Among the other features of the station 10, in accordance with some embodiments of the invention, the station 10 includes a controller 90 (one or more microprocessors and/or microcontrollers, as examples) to coordinate the above-described operations of the station 10. In this regard, the controller 90 may control the operating schedules of the fuel generator 12 and fuel cell-based power generator 30, control the operations of the various valves, control the motors and pumps of the station 10, etc., depending on the particular embodiment of the invention. Thus, the controller 90, various conduits and the above-described valves form at least part of a control subsystem for purposes of controlling operation of the fuel generator 12, operation of the fuel cell-based power generator 30 and regeneration of the beds of the PSA 80 and TSA 56. The controller 90 includes various input terminals 92 that receives status signals, messages, commands, indications of sensed values, etc., from the station 10 and possibly other entities; and includes output terminals 94 for purposes of controlling valves, motors, communicating messages and commands to the station 10 and other entities, etc., depending on the particular embodiment of the invention.

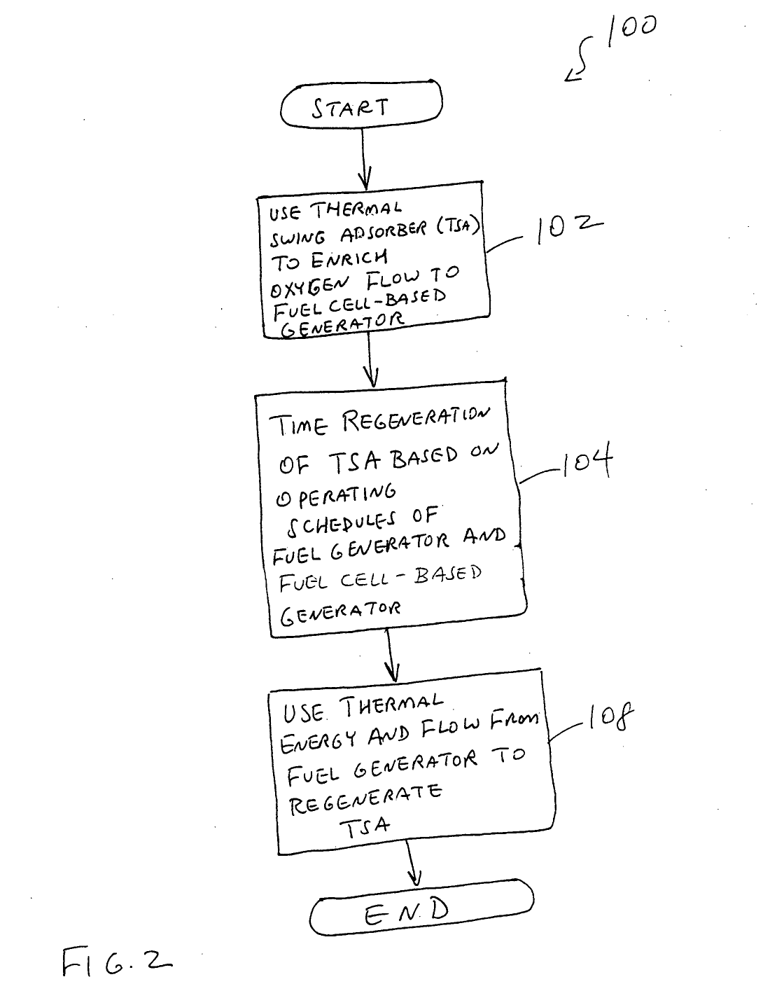

To summarize, FIG. 2 depicts a general technique 100 associated with the use and regeneration of the bed of the TSA 56. Pursuant to the technique 100, the TSA 56 is used to enrich the oxygen flow to the fuel cell-based power generator 30, pursuant to block 102. The regeneration of the TSA 56 is based on operating schedules of the fuel generator 12 and the fuel cell-based power generator 30, pursuant to block 104. Thermal energy and flow from the fuel generator 12 are used to regenerate the bed of the TSA 56, pursuant to block 108.

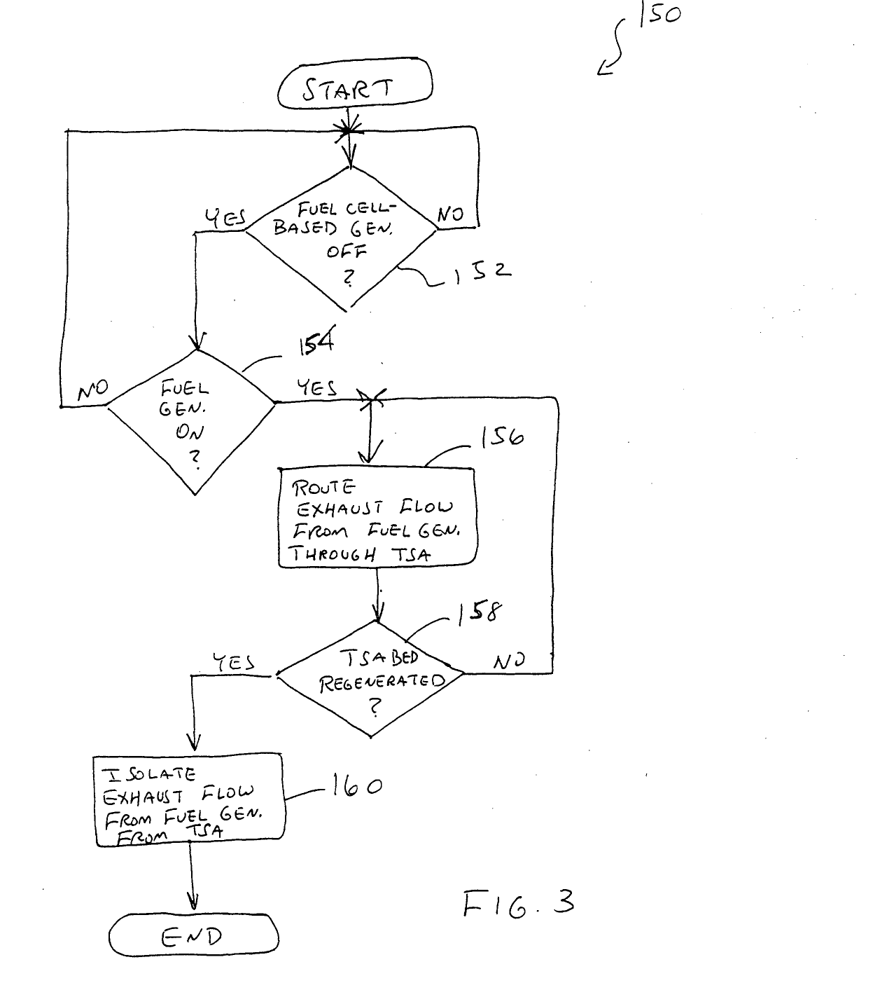

FIG. 3 depicts a more detailed technique 150 related to the regeneration of the bed of the TSA 56. The technique 150 may be performed by execution of firmware or software instructions by the controller 90 (see FIG. 1) in accordance with some embodiments of the invention.

Pursuant to the technique 150, the controller 90 determines (diamond 152) whether the fuel cell-based power generator 30 is shut down. If so, then the controller 90 determines (diamond 154) whether the fuel generator 12 is on, or operating. If the fuel generator 12 is operating, then the controller 90 causes the exhaust flow from the fuel generator 12 to be routed through the bed of the TSA 56. For example, pursuant to block 156, the controller 90 may open the valves 70 and 72. After the controller 90 determines (diamond 158) that the TSA bed has been regenerated, then the controller 90 isolates (block 160) the exhaust flow from the fuel generator 12 from the TSA 56. Thus, pursuant to block 160, the controller 90 may close the valves 70 and 72 (FIG. 1) and eventually reopens the valves 54 and 60 (FIG. 1) in connection with the subsequent start up of the fuel cell-based power generator 30.

In accordance with other embodiments of the invention, the TSA 56 may enrich the oxygen flow to the fuel cell-based power generator 30 by using an alternative adsorption bed in which the bed captures oxygen when cold and releases oxygen when hot. Therefore, during the normal operation of the fuel cell-based power generator 30, the bed of the TSA 56 must remain relatively hot; and when the fuel cell-based power generator 30 is shut down, a relatively cold flow is routed through the TSA 56 for purposes of regenerating its bed. For these embodiments of the invention, the fuel generator 12 and the fuel cell-based power generator 30 may be operating concurrently in that the exhaust flow from the fuel generator 12 is routed through the TSA 56 for purposes of causing its bed to release oxygen.

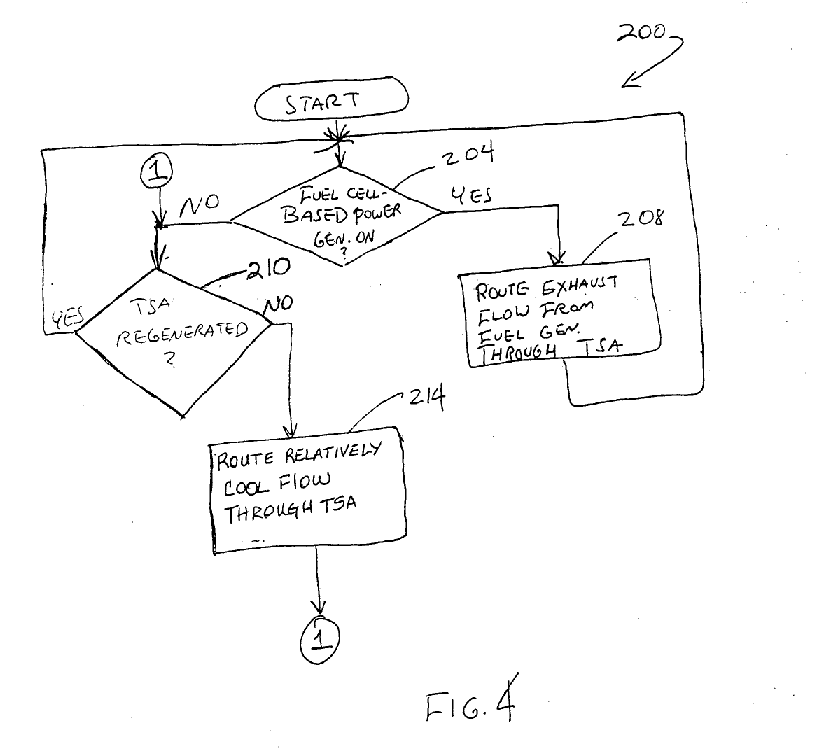

Referring to FIG. 4, for these embodiments of the invention, the controller 90 may use a technique 200. Pursuant to the technique 200, the controller 90 determines (diamond 204) whether the fuel cell-based power generator 30 is operating. If so, the controller 90 routes the exhaust flow from the fuel generator 12 through the bed of the TSA 56, pursuant to block 208. Otherwise, if the fuel cell-based power generator 30 is shut down (diamond 204) and a determination is made (diamond 210) that the TSA bed needs to be regenerated, then the controller 90 routes (block 214) a relatively cool flow through the TSA 56 for purposes of regenerating its bed.

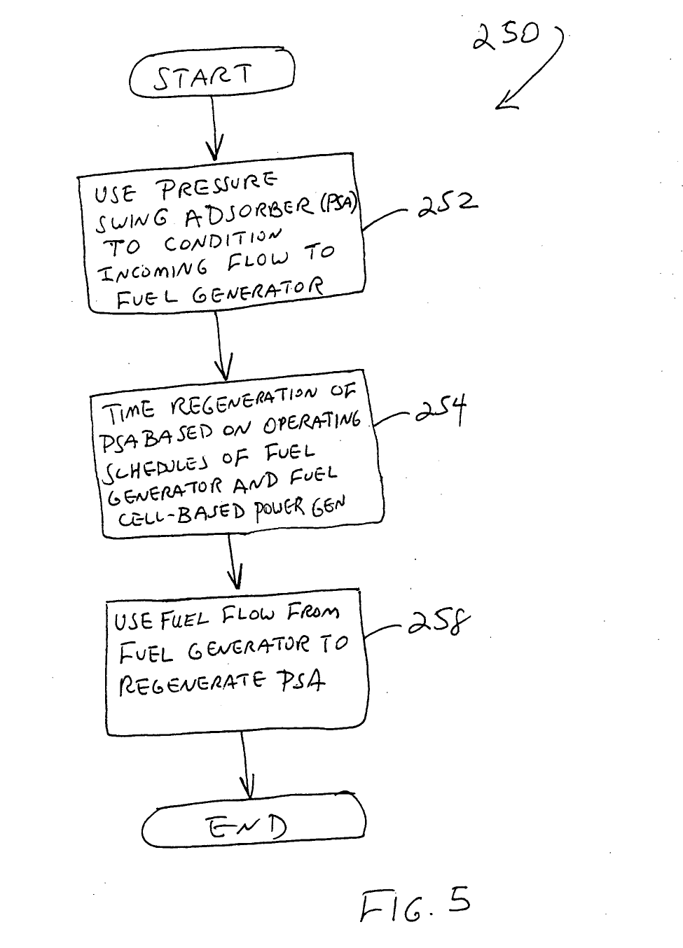

In general, the station 10 may use a technique 250, which is depicted in FIG. 5, in connection with the use and regeneration of the PSA 80. Pursuant to the technique 250, the station 10 uses (block 252) the PSA 80 to condition the incoming flow to the fuel generator 12. In this regard, the PSA 80 may include one or more beds to remove such components as carbon monoxide and water from the incoming hydrocarbon flow. The station 10 times the regeneration of the PSA 80 based on the operating schedules of the fuel generator 12 and the fuel cell-based power generator 30, pursuant to block 254. The station 10 uses (block 258) the fuel flow from the fuel generator 12 to regenerate the bed(s) of the PSA 80.

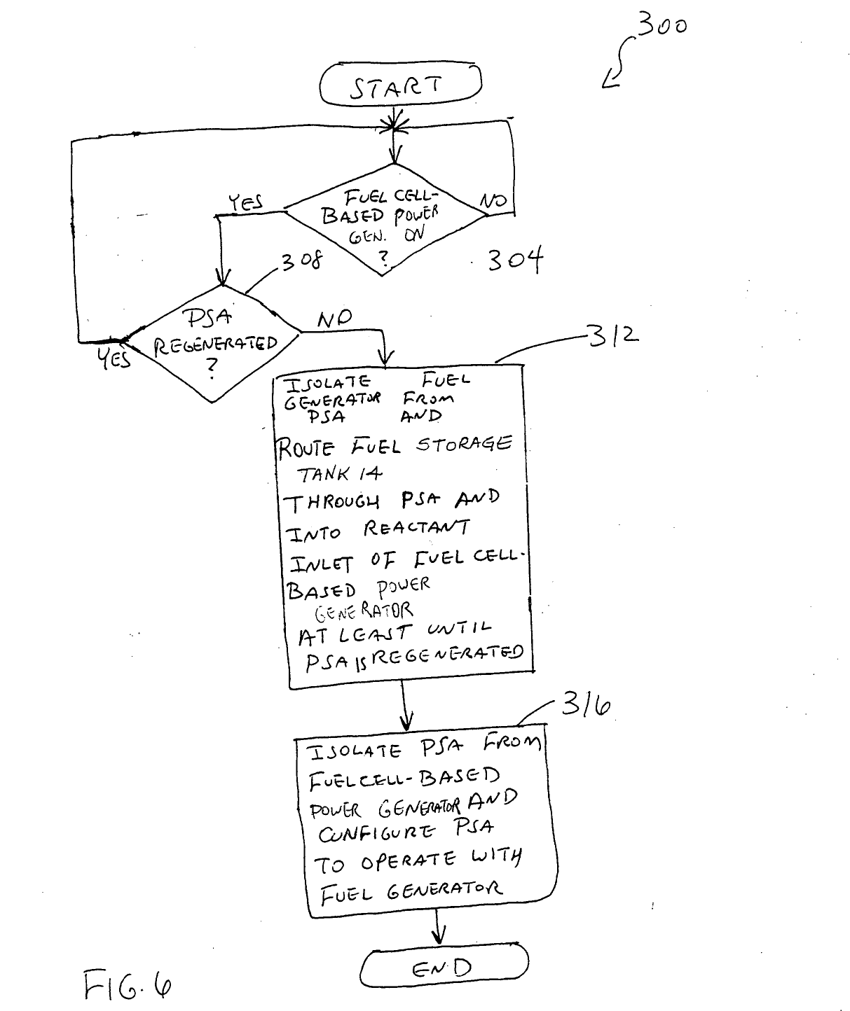

Referring to FIG. 6, as a more specific example, in accordance with some embodiments of the invention, the controller 90 controls the station 10 to regenerate the bed(s) of the PSA 80. Pursuant to the technique 300, the controller 90 determines (diamond 304) whether the fuel cell-based power generator 30 is operating. If so, the controller 90 determines (diamond 308) whether the bed(s) of the PSA 80 need to be regenerated. If so, then the controller 90 isolates the fuel generator 12 from the PSA 80 and routes fuel from the fuel storage tank 14 through the PSA 80 and into the reactant inlet of the fuel cell-based power generator 30 at least until the bed(s) of the PSA 80 are regenerated. Thus, pursuant to block 312, the controller 90 closes the valve 82, opens the valve 71 and configures the valve 20 (see FIG. 1) to flow fuel from the fuel storage tank 14 into the PSA 80.

The reactant inlet of the fuel cell-based power generator 30, which receives the flow from the PSA 80 during its regeneration may either be the anode inlet 22 or the cathode inlet 26, depending on the particular embodiment of the invention. In the case of a PSA that removes only water, the flow from the PSA 80 may be routed to the anode inlet 22 for such cases as when the membranes of the fuel cells of the fuel cell-based power generator 30 uses a low temperature Nafion PEM membrane. Next, the controller 90 isolates (block 316) the PSA 80 from the fuel cell-based power generator 30 and configures the PSA 80 to operate with the fuel generator 12. Thus, pursuant to block 316, the controller 90 may configure the valve 20 (see FIG. 1) to route fuel from the fuel storage tank 14 to the anode inlet 22, close the valve 71 and open the valve 82.

It is noted that the reactant inlet of the fuel cell-based power generator 30, which receives the flow from the PSA 80 during its regeneration may either be the anode inlet 22 or the cathode inlet 26, depending on the particular embodiment of the invention. In the case of a PSA that removes only water, the flow from the PSA 80 may be routed to the anode inlet 22 for such cases as when the membranes of the fuel cells of the fuel cell-based power generator 30 uses a low temperature Nafion PEM membrane. In the case of a PSA that removes water and carbon monoxide, the flow from the PSA 80 may be routed to the anode inlet 22 if a PBI membrane is used in the fuel cells of the generator 30. Additionally, if a humidity transfer device such as an enthalpy wheel or membrane humidifier is used, the water from the PSA may be transferred to the cathode inlet 26 to perform stack humidification.

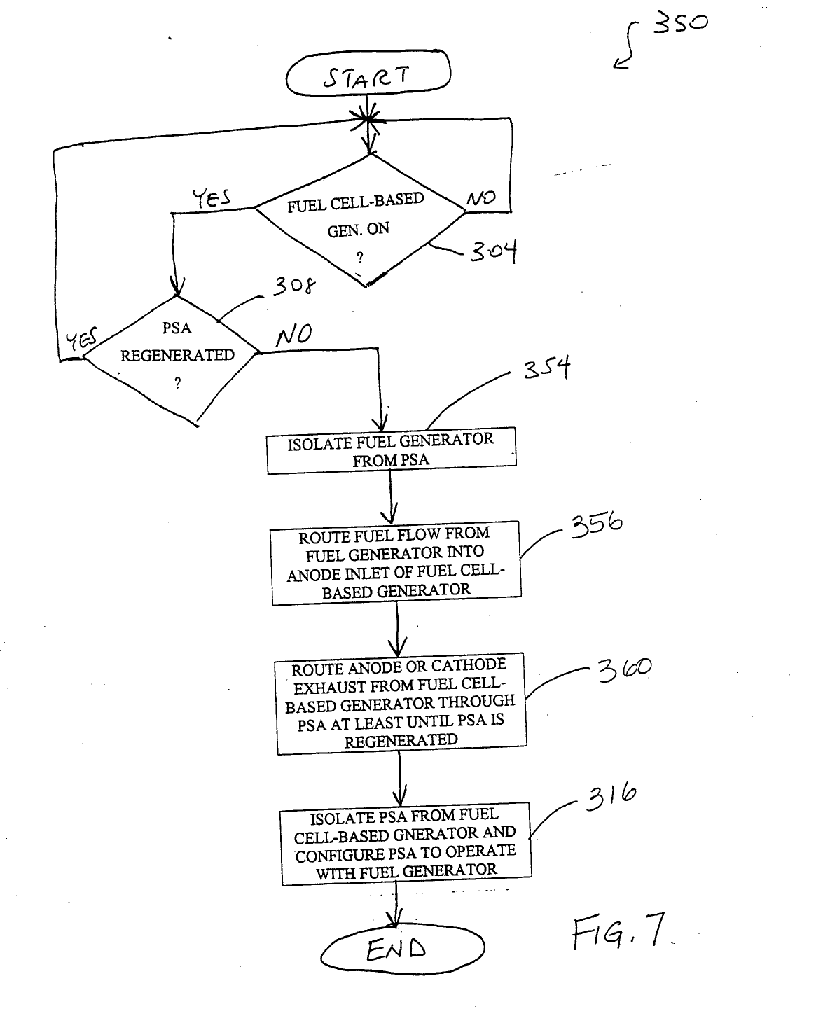

In other embodiments of the invention, the controller 90 may perform a technique 350 that is depicted in FIG. 7 for the case in which an exhaust from the fuel cell-based power generator 30 is used in the regeneration of the bed(s) of the PSA 80. Pursuant to the technique 350, the controller 90 determines (diamond 304) whether the fuel cell-based power generator 30 is operating. If so, the controller 90 determines (diamond 308) whether the bed(s) of the PSA 80 have been regenerated. If not, the controller 90 isolates (block 354) the fuel generator 12 from the PSA 80 and routes (block 356) fuel flow from the fuel generator 12 into the anode inlet 22 of the fuel cell-based power generator 30. Next, the controller 90 routes the anode and cathode exhaust from the fuel cell-based power generator 30 through the PSA 80 at least until the bed(s) of the PSA 80 are regenerated. Subsequently, the controller 90 isolates (block 316) the PSA 80 from the fuel cell-based power generator 30 and configures the PSA 80 to operate with the fuel generator 12.

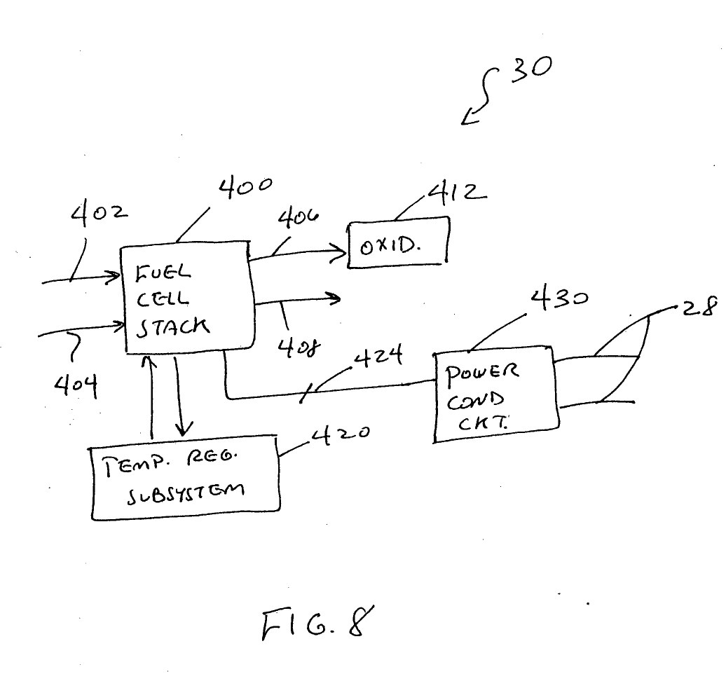

FIG. 8 depicts an exemplary embodiment of the fuel cell-based power generator 30 in accordance with some embodiments of the invention. The fuel cell-based power generator 30 includes a fuel cell stack 400, which may be a stack of PEM fuel cells, in accordance with some embodiments of the invention. The fuel cell stack 400 includes an anode chamber inlet 402 and a cathode chamber inlet 404. In this regard, the incoming flow through the anode inlet 22 is routed into the anode inlet 402 and passes through the anode chamber of the fuel cell stack 400. The flow exits the anode chamber at an anode exhaust outlet 406 of the fuel cell stack 400. In the context of this application, the “anode chamber” of the fuel cell stack 40 refers to the anode inlet and outlet plenum passageways as well as the anode flow plate channels of the stack 400.

The cathode inlet 404 of the fuel cell stack 400 is in communication with the cathode inlet 26 (see FIG. 1). Thus, the incoming oxidant flow flows through the cathode inlet 404, through the cathode chamber of the fuel cell stack 400 and exits the stack 400 at its cathode exhaust outlet 408. In the context of this application, the “cathode chamber” refers to the inlet and outlet plenum passageways as well as the cathode flow plate channels of the stack 400.

In accordance with some embodiments of the invention, the anode exhaust from the fuel cell stack 400 may be routed to an oxidizer 412, an oxidizer that may be part of the fuel generator 12 in accordance with some embodiments of the invention. Additionally, although FIG. 8 does not depict the exhaust from the fuel cell stack 400 being rerouted to the anode inlet 402, in accordance with some embodiments of the invention, the anode exhaust may be recirculated through the anode chamber of the fuel cell stack 400. Furthermore, in other embodiments of the invention, the anode chamber of the fuel cell stack 400 may be closed off at its output and thus, may be “dead-headed.” Additionally, in accordance with some embodiments of the invention, a bleed flow may be established from the anode exhaust, and the remaining portion of the anode exhaust may be recirculated back to the anode inlet 402. As yet another example, the cathode exhaust may be recirculated back to the anode inlet 402, in other embodiments of the invention. Thus, many variations are possible and are within the scope of the appended claims.

Among the other features of the fuel cell-based power generator 30, in accordance with some embodiments of the invention, the generator 30 includes a temperature regulation subsystem 420 that may, for example, circulate a coolant through the fuel cell stack 400 for purposes of regulating the stack temperature. Additionally, the fuel cell-based power generator 30 may include power conditioning circuitry 430 that is in communication with DC stack terminals 424 for purposes of conditioning the power received from the fuel cell stack 400 into the appropriate form (AC or DC) and level for the load 40 (see FIG. 1). In this regard, the power conditioning circuitry 430 may regulate the DC level that is provided to the load 40 for cases in which the load 40 is a DC load. In other embodiments of the invention, the power conditioning circuitry 430 may convert the DC stack voltage into an AC voltage and regulate this AC voltage to the appropriate level for the case in which the load 40 is an AC load. Thus, many variations are possible and are within the scope of the appended claims.

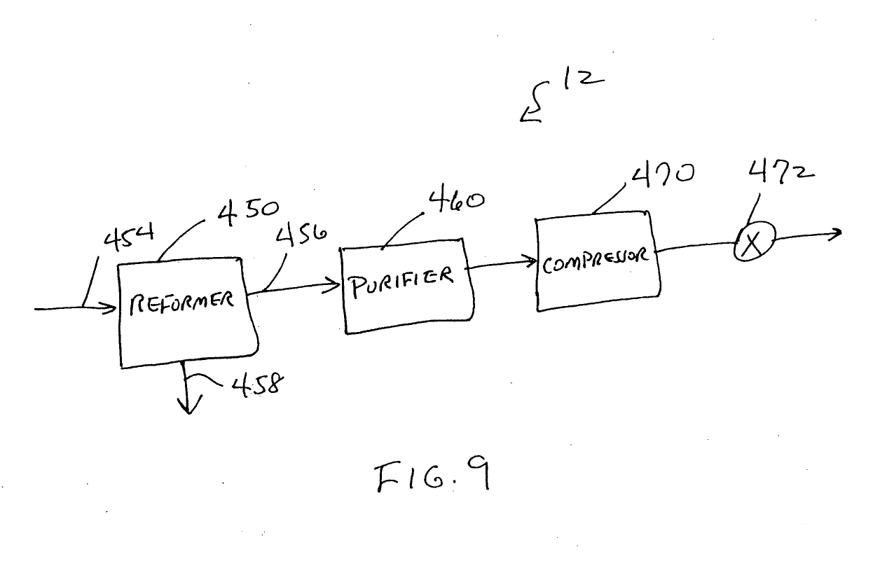

FIG. 9 depicts an exemplary embodiment of the fuel generator 12. As depicted in FIG. 9, the fuel generator 12 may include a reformer 450 that has an inlet 454 that receives the incoming flow from the PSA 80. The reformer 450 may use a number of different reforming processes, such as autothermal reforming, catalytic partial oxidation (CPO), steam reforming, etc. The reformer 450 may include an oxidizer that produces an exhaust flow at an exhaust outlet 458. This exhaust flow may be used to purge the bed of the TSA 56, as described above. Additionally, the reformer 450 includes an outlet 456 that provides its product, called “reformate,” to a purifier 460. The reformate may, for example, contain approximately fifty percent hydrogen by volume. The purifier 460, as its name implies, purifies the incoming flow into a substantially pure fuel (such as pure hydrogen) at its output terminal. In accordance with some embodiments of the invention, the purifier 460 may be an electrochemical stack, such as a hydrogen pump. Additionally, in accordance with some embodiments of the invention, the purifier 460 may be integral with the fuel cell stack 400 (see FIG. 8), as the purifier may receive electrical power from a power producing portion of the stack 400. As another example, in accordance with some embodiments of the invention, the purifier 460 and the fuel cell stack 400 may share the same flow plates, gas diffusion layers (GDLs), membranes, etc. in that the times in which the purifier 460 and fuel cell stack 400 operate are mutually exclusive. In other embodiments of the invention, the purifier 460 and the fuel cell stack 400 may be mechanically and electrically separate. Thus, many variations are possible and are within the scope of the appended claims.

In addition to the reformer 450 and the purifier 460, the fuel generator 12 includes a compressor 470 and a valve 472. In this regard, during operation of the fuel generator 12, the valve 472 is open and the compressor 470 operates to store pressurized gas in the fuel storage tank 14 (see FIG. 1).

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A system comprising:
a fuel generator to provide fuel, the fuel generator having an exhaust flow;
a thermal swing adsorber comprising a bed to enrich a first oxidant flow with oxygen to produce a second oxidant flow;
a fuel cell-based power generator to produce electrical power in response to the second oxidant flow and the fuel; and
a subsystem to route the exhaust flow from the fuel generator to the thermal swing adsorber to regenerate the bed.

2. The system of claim 1, wherein the subsystem is adapted to time the regeneration of the bed based on operating schedules of the fuel generator and fuel cell-based power generator.

3. The system of claim 1, wherein the subsystem is adapted to route the exhaust flow through the bed in response to the fuel cell-based power generator being shut down.

4. The system of claim 3, wherein the subsystem is adapted to route the exhaust flow through the bed in response to the fuel generator operating to produce the fuel.

5. The system of claim 1, wherein the fuel generator comprises a reformer.

6. The system of claim 5, wherein the fuel generator further comprises a purifier to purify a flow from the reformer.

7. The system of claim 1, wherein the exhaust flow communicates thermal energy from the fuel generator to regenerate the bed.

8. The system of claim 1, wherein the exhaust flow purges the bed.

9. A system comprising:
a fuel generator to provide fuel, the fuel generator having an exhaust flow;
a thermal swing adsorber comprising a bed to enrich the exhaust flow with oxygen to produce an oxidant flow; and
a fuel cell-based power generator to produce electrical power in response to the oxidant flow and the fuel.

10. The system of claim 9, wherein the subsystem is adapted to route another flow having a significantly cooler temperature than the exhaust flow through the bed to regenerate the bed.

11. A system comprising:
a pressure swing adsorber to provide a fuel flow;
a fuel generator to purify the fuel flow to produce substantially purified fuel;
a fuel cell-based power generator to produce electrical power in response to an oxidant flow and the substantially purified fuel; and
a subsystem to route a flow associated with the fuel cell-based power generator to regenerate the bed.

12. The system of claim 11, wherein the subsystem is adapted to time the regeneration of the bed based on operating schedules of the fuel generator and fuel cell-based power generator.

13. The system of claim 11, wherein the fuel cell-based power generator comprises a fuel cell stack, and said flow associated with the fuel cell-based power generator comprises one of an anode flow to the fuel cell stack, a cathode flow to the fuel cell stack, an anode flow from the fuel cell stack and a cathode flow from the fuel cell stack.

14. The system of claim 11, wherein the subsystem is adapted to route said flow associated with the fuel cell-based power generator through the bed in response to the fuel generator being shut down.

15. The system of claim 11, wherein the fuel generator comprises a reformer to receive a flow from the pressure swing adsorber.

16. The system of claim 15, wherein the fuel generator further comprises a purifier to purify a flow from the reformer.

17. A method comprising:
flowing a first oxidant flow through a thermal swing adsorber to enrich the first oxidant flow with oxygen to produce a second oxidant flow;
routing the second oxidant flow to a fuel cell-based power generator to produce electrical power; and
routing an exhaust flow from a fuel generator through a bed of the thermal swing adsorber to regenerate the bed.

18. The method of claim 17, further comprising timing the regeneration of the bed based on operating schedules of the fuel generator and the fuel cell-based power generator.

19. The method of claim 17, wherein the act of routing occurs in response to the fuel cell-based power generator being shut down.

20. The method of claim 17, wherein the act of routing comprises routing the exhaust flow through the bed in response to the fuel generator operating to produce the fuel.

21. The method of claim 17, wherein the act of routing comprises routing the exhaust flow from a reformer of the fuel generator.

22. A method comprising:
routing an exhaust flow from a fuel generator through a thermal swing adsorber to enrich the exhaust flow with oxygen to produce an oxidant flow; and
routing the oxidant flow to a fuel cell-based power generator to produce electrical power.

23. The method of claim 22, further comprising:
routing another flow having a significantly cooler temperature than the exhaust flow through the bed to regenerate the bed.

24. A method comprising:
purifying a fuel flow provided by a pressure swing adsorber to produce substantially purified fuel;
using the substantially purified fuel to produce electrical power from a fuel cell-based power generator; and
routing a flow associated with the fuel cell-based power generator to regenerate a bed of the pressure swing adsorber.

25. The method of claim 24, further comprising:
timing the regeneration of the bed based on operating schedules of the fuel generator and the fuel cell-based power generator.

26. The method of claim 24, wherein the act of routing the flow associated with the fuel cell-based power generator comprises at least one of the following:
communicating the flow from the pressure swing adsorber to an anode inlet of the fuel cell-based power generator;
communicating the flow from the pressure swing adsorber to a cathode inlet of the fuel cell-based power generator;
communicating the flow from an anode outlet of the fuel cell-based power generator to the pressure swing adsorber; and
communicating the flow from a cathode outlet of the fuel cell-based power generator to the pressure swing adsorber.

27. The method of claim 24, wherein the act of routing the flow associated with the fuel cell-based power generator through the bed occurs in response to the fuel generator being shut down.

28. The method of claim 24, further comprising:
communicating a flow from the pressure swing adsorber to a reformer of the fuel generator.

29. The method of claim 28, further comprising:
purifying a flow from the reformer to produce substantially purified fuel; and
storing the substantially purified fuel in a tank.
